(19) United States
(12) Patent Application Publication
(10) Pub. No.: US 2022/0093957 A1
(43) Pub. Date: Mar. 24, 2022

(54) CELL, BATTERY ASSEMBLY AND ELECTRONIC DEVICE

(71) Applicant: BEIJING XIAOMI MOBILE SOFTWARE CO., LTD., Beijing (CN)

(72) Inventors: Sihong DU, Beijing (CN); Helin JIANG, Beijing (CN)

(73) Assignee: BEIJING XIAOMI MOBILE SOFTWARE CO., LTD., Beijing (CN)

(21) Appl. No.: 17/334,539

(22) Filed: May 28, 2021

(30) Foreign Application Priority Data
Sep. 23, 2020 (CN) 202011012709.5

(51) Int. Cl. H01M 10/04

(52) U.S. Cl. CPC H01M 10/0431; H01M 2220/30

(57) ABSTRACT

The present disclosure provides a cell, a battery assembly, and an electronic device. The cell includes first electrode, second electrode, diaphragm, and fixing member which are sequentially laminated to one another and wound to form a bare cell body. The first electrode is located at outermost side of the bare cell body and includes first end portion located on an outer surface of the bare cell body. The first electrode is provided with a first active layer extending to the first end portion. The first end portion is fixed to the outer surface of the bare cell body by the fixing member.

### CROSS-REFERENCE TO RELATED APPLICATION

This application is based on and claims priority to Chinese Patent Application No. 202011012709.5, filed on Sep. 23, 2020, the entire content of which is incorporated herein by reference for all purposes.

### BACKGROUND

The present disclosure relates to the technical field of batteries, and particularly to a cell, a battery assembly and an electronic device.

With the development of electronic devices, batteries with large energy densities are popular. The energy density of the battery is associated with a material of the battery, a structure of the cell and a content of an active layer on the cell. For example, the cell includes a first electrode piece, a separator and a second electrode piece sequentially laminated to one another. The first electrode piece, the separator and the second electrode piece are wound to form a bare cell body. The first electrode piece is located at an outermost side, and the energy density of the cell is affected by the content of the active layer on the first electrode piece and the second electrode piece. However, the first electrode piece requires a blank current collector to be reserved to meet an encapsulation requirement, which is detrimental to increasing the energy density of the cell.

### SUMMARY

The present disclosure provides a cell, a battery assembly, and an electronic device.

According to a first aspect of the present disclosure, a cell is provided, including a first electrode, a second electrode, a diaphragm, and a fixing member; wherein the first electrode, the diaphragm and the second electrode are laminated to one another and wound to form a bare cell body, the first electrode being disposed at an outermost side of the bare cell body; and wherein the first electrode comprises a first end located on an outer surface of the bare cell body, the first electrode comprising a first active layer extending to the first end, and the first end being fixed to the outer surface of the bare cell body by the fixing member.

According to a second aspect of the present disclosure, a battery assembly is provided, including a cell, wherein the cell comprises a first electrode, a second electrode, a diaphragm and a fixing member; wherein the first electrode, the diaphragm and the second electrode are laminated to one another and wound to form a bare cell body, the first electrode piece being disposed at an outermost side of the bare cell body; and wherein the first electrode comprises a first end located on an outer surface of the bare cell body, the first electrode comprising a first active layer extending to the first end, the first end being fixed to the outer surface of the bare cell body by the fixing member.

According to a third aspect of the present disclosure, an electronic device is provided, including a battery assembly that comprises a cell comprising a first electrode, a second electrode, a diaphragm and a fixing member; wherein the first electrode, the diaphragm and the second electrode are laminated to one another and wound to form a bare cell body, the first electrode being disposed at an outermost side of the bare cell body; and wherein the first electrode comprises a first end located on an outer surface of the bare cell body, the first electrode comprising a first active layer extending to the first end, and the first end being fixed to the outer surface of the bare cell body by the fixing member.

### BRIEF DESCRIPTION OF THE DRAWINGS

FIG. 1 is a schematic view of a cell in the related art;

FIG. 2 is a schematic view of a cell according to an example of the present disclosure;

FIG. 3 is a partial schematic view of a first electrode piece according to an example of the present disclosure;

FIG. 4 is a partial schematic view of a second electrode piece according to an example of the present disclosure;

FIG. 5 is a partial schematic structural view of a cell according to an example of the present disclosure.

### DETAILED DESCRIPTION

The exemplary embodiments will be described in detail herein, examples of which are illustrated in the accompanying drawings. When the following description refers to the drawings, the same numbers in different drawings indicate the same or similar elements unless otherwise indicated. The embodiments described in the following exemplary embodiments do not represent all embodiments consistent with the present disclosure. On the contrary, they are merely examples of devices and methods consistent with some aspects of the disclosure as detailed in the appended claims.

The terms used in the present disclosure are only for the purpose of describing particular embodiments and are not intended to limit the present disclosure. Unless defined otherwise, technical or scientific terms used in the present disclosure shall be in the ordinary sense understood by those of ordinary skill in the art to which the disclosure belongs. The terms “first”, “second” and similar words used in the present disclosure and claims are only used to distinguish between different components, and cannot denote any order, quantity or importance. Similarly, the terms “a” or “an” or the similar words cannot denote a quantitative limitation, but rather denote the presence of at least one. Unless otherwise specified, the terms “include” or “comprise” or the similar words mean that elements or objects in front of “include” or “comprise” cover the elements or the objects listed after “include” or “comprise”, and cannot exclude other elements or objects. The terms “connect” or “link” and the similar words are not limited to physical or mechanical connections, and may include electrical connections, whether direct or indirect.

As used in this disclosure and the appended claims, the singular forms “a”, “the”, and “this” are also intended to include the plural forms unless the context clearly dictates otherwise. It is also to be understood that the term “and/or”, as used herein, refers to encompasses any or all possible combinations of one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

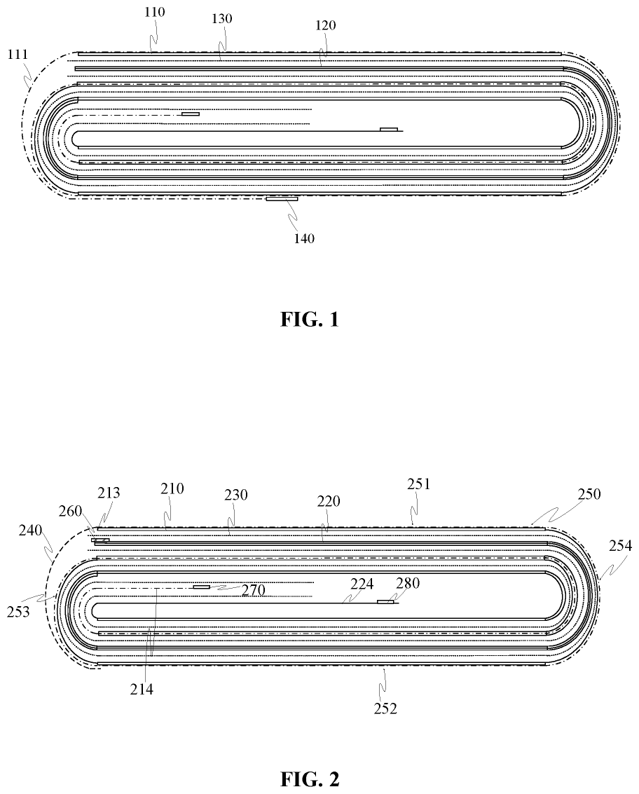

FIG. 1 is a schematic structural view of a cell in the related art. Referring to FIG. 1, a cell includes a first electrode piece 110, a second electrode piece 120, a diaphragm 130 and a fixing member 140. The first electrode piece 110, the diaphragm 130 and the second electrode piece 120 are sequentially laminated to one another and wound to form a bare cell body, and the first electrode piece 110 is located at an outermost side. The first electrode piece 110 includes a blank current collector 111 where an active layer is absent, the blank current collector 111 is wound and wrapped around an outer surface of the bare cell body, and then the blank current collector is fixed to the outer surface of the bare cell body by the fixing member 140. Since no active layer is provided on the blank current collector 111, the blank current collector cannot store electric energy for the cell. In addition, the blank current collector 111 occupies the space of the bare cell body, which is detrimental to increasing the energy density of the cell.

In order to solve the above problems, an example of the present disclosure provides a cell, a battery assembly and an electronic device, which are described in detail below in connection with the accompanying drawings:

Some examples of the present disclosure provide an electronic device which includes a battery assembly. The electronic device includes, but is not limited to: a mobile phone, a tablet computer, an iPad, a digital broadcast terminal, an information transmitter-receiver, a game console, a medical device, an exercise device, a personal digital assistant, an intelligent wearable device, an intelligent television, a floor sweeping robot, an intelligent sound box, and the like.

The example of the disclosure provides a battery assembly for powering an electronic device. The battery assembly includes a cell. The battery assembly may further include a battery protection plate. The cell is connected to the battery protection plate, the battery protection plate is connected to the mainboard of the electronic device, and the mainboard of the electronic device is connected to a charging interface. A charging current input to the cell and a supply current output by the cell are adjusted through the battery protection plate.

In an example, the battery assembly is a lithium ion battery assembly and the cell is a lithium ion cell.

FIG. 2 is a schematic view of a cell according to an example of the present disclosure. Referring to FIG. 2, the cell includes a first electrode piece 210, a second electrode piece 220, a diaphragm 230 and a fixing member 240.

The first electrode piece 210, the diaphragm 230 and the second electrode piece 220 are sequentially laminated to one another and wound to form a bare cell body 250, and the first electrode piece 210 is located at an outermost side. It should be understood that the first electrode piece 210, the diaphragm 230 and the second electrode piece 220 sequentially laminated, are regarded as one layer. When they are wound, the first electrode piece 210 is always located at the outermost side, and the second electrode piece 220 is always located at an innermost side. In an example, one of the first electrode piece 210 and the second electrode piece 220 is a positive electrode piece and the other is a negative electrode piece. In an example, the first electrode piece 210 may be the positive electrode piece and the second electrode piece 220 may be the negative electrode piece.

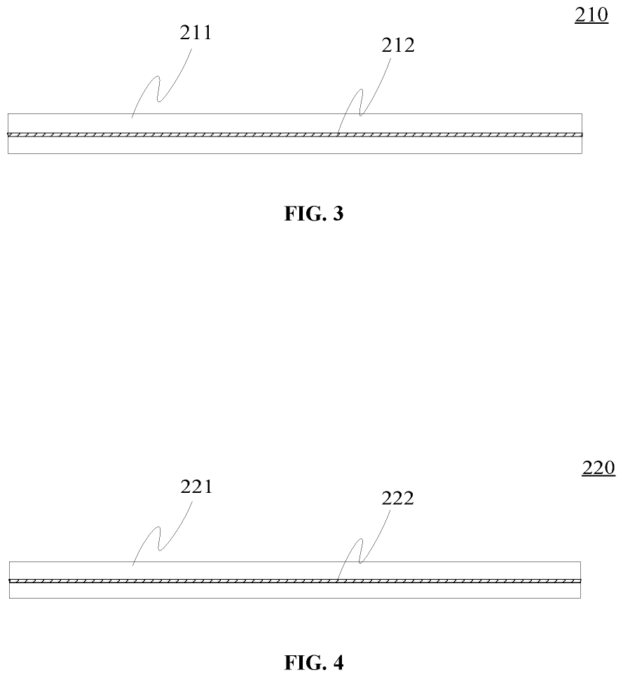

FIG. 3 is a partial schematic structural view of a first electrode piece according an example of the present disclosure, and FIG. 4 is a partial schematic structural view of a second electrode piece according to an example of the present disclosure. In an example, referring to FIG. 3, both surfaces of the first electrode piece 210 may be provided with a first active layer 211 which is facilitating to increasing the energy density of the cell. Referring to FIG. 4, both surfaces of the second electrode piece 220 may be provided with a second active layer 221, which is facilitating to increasing the energy density of the cell. When the first electrode piece 210 is the positive electrode piece, the first active layer 211 is a positive active layer; and when the second electrode piece 220 is the negative electrode piece, the second active layer 221 is a negative pole active layer.

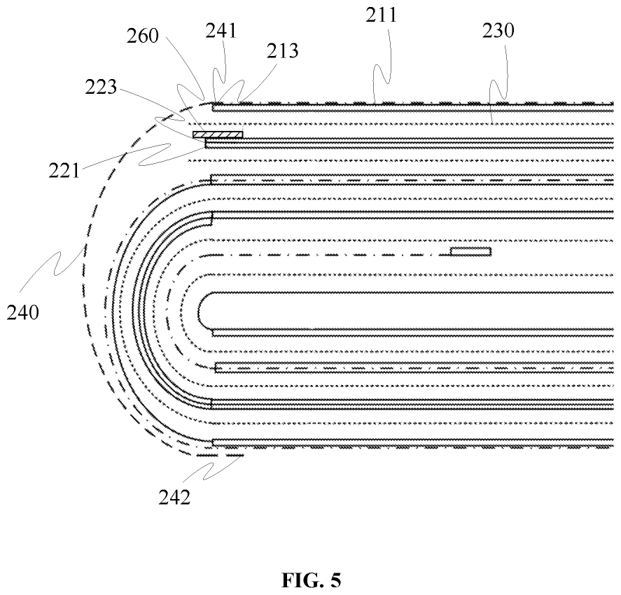

FIG. 5 is a partial schematic structural view of a cell according to an example of the present disclosure. Referring to FIG. 5, the first electrode piece 210 includes a first end portion 213 located on an outer surface of the bare cell body 250. The first electrode piece 210 is provided with the first active layer 211 extending to the first end portion 213, and the first end portion 213 is fixed to the outer surface of the bare cell body 250 by a fixing member 240. It should be noted that the first electrode piece 210 includes a first end portion 213, which is located on the outer surface of the bare cell body 250, and a second end portion opposite to the first end portion 213 which is wound within the bare cell body 250. In an example, with reference to FIG. 3, the first electrode piece 210 includes a first current collector 212 and the first active layer 211 overlying the first current collector 212 With reference to FIG. 4, the second electrode piece 220 includes a second current collector 222 and the second active layer 221 overlying the second current collector 222.

Based on the above, the cell provided by the example of the present disclosure is based on the first electrode piece 210, the diaphragm 230 and the second electrode piece 220 which are sequentially laminated to one another and wound to form the bare cell body 250. The first electrode piece 210 is located on the outermost side of the bare electric cell body 250. The first electrode piece 210 includes the first end portion 213 located on the outer surface of the bare cell body 250. Since the first active layer 211 extends to the first end portion 213 which is fixed to the outer surface of the bare cell body 250 by the fixing member 240, there is no blank current collector existed on the first electrode piece 210 located on the outermost side, thus the first electrode piece 210 can store more electric energy. The first electrode piece 210 makes full use of the space of the bare cell body to increase energy density of the cell.

In some examples, with reference to FIG. 5, the first end portion 213 is connected with one end of the fixing member 240. Another end of the fixing member 240 is wound and fixed onto the outer surface of the bare cell body 250 in an extension direction of a winding trajectory of the first electrode piece 210. It should be understood that the extension direction of the winding trajectory of the first electrode piece 210 is the winding direction. The fixing member 240 is wound on the outer surface of the bare cell body 250, that is, the fixing member 240 is wound on the outer surface of the first electrode piece 210. In this way, it is beneficial to the firm fixing of the first electrode piece 210 by the fixing member 240, thereby stabilizing the structure of the entire bare cell body 250.

In the example of the present disclosure, the bare cell body 250 may be of a variety of structures, such as cylindrical structure, square structure, or other regular or irregular structure. In some examples, with reference to FIG. 2, the bare cell body 250 includes a first flat surface 251, a second flat surface 252 opposite to the first flat surface 251, and a first curved arc surface 253 between the first flat surface 251 and the second flat surface 252. The fixing member 240 extending from the first flat surface 251 to the second flat surface 252 around the first curved arc surface 253. In other words, the bare cell body 250 has a structure similar to square, and the fixing member 240 is wrapped around the first curved arc surface 253. It should be understood that the first curved arc surface 253 protrudes outward from an inside of the bare cell body 250. The first curved arc surface 253 is the outermost arc surface between the first flat surface 251 and the second flat surface 252. The first curved arc surface 253 is an arc surface formed by bending the first electrode piece 210. In this way, it is beneficial to the firm fixing of the first electrode piece 210 to the outer surface of the bare cell body 250 by the fixing member 240. In an example, a size of the first flat surface 251 and a size of the second flat surface 252 are both larger than a size of the first curved arc surface 253 in the extension direction of the winding trajectory. In this way, a shorter length of the fixing member 240 can be used for wrapping, thereby preventing the fixing member 240 from occupying a larger space and affecting the energy density of the cell.

Further, in some examples, with reference to FIGS. 2 and 5, the cell body further includes a second curved arc surface 254 opposite to the first curved arc surface 253. The second curved arc surface 254 is located between the first flat surface 251 and the second flat surface 252. The fixing member 240 includes a first fixing end portion 241 fixed to the first plane surface 251 and a second fixing end portion 242 fixed to the second plane surface 252. The first fixing end portion 241 and the second fixing end portion 242 are both close to the first curved arc surface 253 between the first curved arc surface 253 and the second curved arc surface 254. It should be understood that the fixing member 240 between the first fixing end portion 241 and the second fixing end portion 242 is wrapped around the first curved arc surface 253. In this way, on the premise that the fixing member 240 can firmly fix the bare cell body 250 stably, a shorter fixing member 240 can be used to reduce the space occupied by the fixing member 240, thereby improving the energy density of the cell.

In some examples, the fixing member 240 includes adhesive paper wrapped and bonded to the outer surface of the bare cell body 250. The adhesive paper is thin and occupies less space, so that it is conducive to increase the energy density of the cell. In addition, the method of bonding by the adhesive paper is simple, thereby facilitating the fixing of the bare cell body 250.

In some examples, with reference to FIG. 5, the second electrode piece 220 includes a third end portion 223 located at the outermost side and a fourth end portion located inside of the bare cell body 250. The third end portion 223 is provided with a second active layer 221. The third end portion 223 of the second electrode piece 220 extends beyond the first end portion 213 of the first electrode piece 210 toward the fixing member 240. In this way, the third end portion 223 of the second electrode piece 220 inevitably has a burr, which is possible to easily pierce the diaphragm 230 and the fixing member 240, and thus the electrical conduction may be occurred between the third end portion 223 of the second electrode piece 220 and a encapsulating case such as an aluminum-plastic film of the bare cell body 250. When the first electrode piece 210 is the positive electrode piece and the second electrode piece 220 is the negative electrode piece, a short circuit or an electrochemical corrosion is easily formed between the second electrode piece 220 and the encapsulating case such as the aluminum-plastic film, so that safety problems such as the short circuit and the corrosion of the encapsulating case such as the aluminum-plastic film are easily caused. To solve this problem, in some examples with reference to FIG. 2 or 5, the second electrode piece 220 includes the third end portion 223 located at the outermost side, the cell further includes an insulating protective member 260. The insulating protective member is arranged between, a joint of the first end portion 213 and the fixing member 240, and the third end portion 223 of the second electrode piece 220. By the insulating protective member 260, it is possible to prevent the third end portion 223 of the second electrode piece 220 from puncturing the fixing member 240, thereby avoiding the problems such as the short circuit and the corrosion of the encapsulating case such as the aluminum-plastic film of the bare cell body 250.

In some examples, with reference to FIG. 2, the insulating protective member 260 is arranged between the diaphragm 230 and the third end portion 223. In an example, the insulating protective member 260 is arranged on the diaphragm 230 to prevent the third end portion 223 of the second electrode piece 220 from piercing the diaphragm 230. In an example, the insulating protective member 260 is provided at the third end 223 to prevent the third end 223 of the second electrode piece 220 from piercing the diaphragm 230. Further, the insulating protective member 260 is bonded to the third end portion 223 for example. The bonding method is simple and easy to operate. In an example, the insulating protective member 260 may be an insulating adhesive layer.

In some examples, a distal end of the diaphragm 230 located at the outermost side extends beyond the third end portion 223 in a direction toward the fixing member 240. In an example, the distal end 230 the diaphragm 230 located at the outermost side extends beyond the third end portion 223 in a direction toward the fixing member 240 by 2 mm to 10 mm, such as 2 mm, 3 mm, 4 mm, 5 mm, 6 mm, 7 mm, 8 mm, 9 mm, 10 mm, etc. Thus, the diaphragm 230 and the insulating protective member 260 are cooperated with one another to effectively prevent the third end portion 223 of the second electrode piece 220 from piercing the fixing member 240.

In some examples, with reference to FIG. 2, the first electrode piece 210 includes a first blank current collector 214 wrapped within the bare cell body 250. The second electrode piece 220 includes a second blank current collector 224 wrapped within the bare cell body 250. The cell further includes a first pole lug 270 electrically connected to the first blank current collector 214 and a second pole lug 280 electrically connected to the second blank current collector 224.

In some examples, with reference to FIG. 5, an inner surface of the first electrode piece 210 located at the outermost side of the bare cell body 250 is provided with the first active layer 211, and an outer surface of the first electrode piece 210 located at the outermost side of the bare cell body 250 is not provided with the first active layer 211. In this way, the space of the bare cell body 250 is fully utilized, and a waste of the first active layer 211 is avoided.

In summary, the cell, the battery assembly, and the electronic device provided in this example of the present disclosure are based on the first electrode piece 210, the separator 230, and the second electrode piece 220 which are sequentially laminated to one another and wound to form the bare cell body 250. The first electrode piece 210 is located on the outermost side of the bare electric cell body 250. The first electrode piece 210 includes the first end portion 213 located on the outer surface of the bare cell body 250. Since the first active layer 211 extends to the first end portion 213 which is fixed to the outer surface of the bare cell body 250 by the fixing member 240, there is no blank current collector existed on the first electrode piece 210 located on the outermost side, thus the first electrode piece 210 can store more electric energy. The first electrode piece 210 makes full use of the space of the bare cell body to increase energy density of the cell. By arranging the insulating protective member 260 between, a joint of the first end portion 213 of the first electrode piece 210 and the fixing member 240, and the third end portion 223, the burr of the third end portion 223 of the second electrode piece 220 can be prevented from puncturing the diaphragm 230 and the fixing member 240, thereby avoiding the problem of the short circuit or the corrosion of the encapsulating case such as the aluminum-plastic film of the bare cell body 250.

The above-described examples of the present disclosure may be complementary to each other without conflict.

The above are only the preferred examples of the present disclosure and are not intended to limit the present disclosure. Any modifications, equivalents, improvements, etc. which fall within the spirit and principles of the present disclosure are intended to be included within the scope of protection of the present disclosure.

1. A cell, comprising a first electrode, a second electrode, a diaphragm, and a fixing member;
wherein the first electrode, the diaphragm and the second electrode are laminated to one another and wound to form a bare cell body, the first electrode being disposed at an outermost side of the bare cell body; and
wherein the first electrode comprises a first end located on an outer surface of the bare cell body and a second end opposite to the first end, the first electrode comprising a first active layer extending to the first end, and the first end being fixed to the outer surface of the bare cell body by the fixing member.

2. The cell according to claim 1, wherein the first end is connected with one end of the fixing member, another end of the fixing member being wound and fixed onto the outer surface of the bare cell body in an extension direction of a winding trajectory of the first electrode.

3. The cell according to claim 2, wherein the bare cell body comprises a first flat surface, a second flat surface opposite to the first flat surface, and a first curved arc surface between the first flat surface and the second flat surface, and the fixing member extends from the first flat surface to the second flat surface around the first curved arc surface.

4. The cell according to claim 1, wherein the fixing member comprises adhesive paper wrapped and bonded to the outer surface of the bare cell body.

5. The cell according to claim 1, wherein the second electrode comprises a third end located at the outermost side of the bare cell body, the cell further comprises an insulating protective member disposed between: a joint of the first end and the fixing member, and the third end.

6. The cell according to claim 5, wherein the insulating protective member is disposed between the diaphragm and the third end.

7. The cell according to claim 6, wherein the insulating protective member is bonded to the third end.

8. The cell according to claim 5, wherein a distal end of the diaphragm located at the outermost side of the bare cell body extends beyond the third end in a direction toward the fixing member.

9. The cell according to claim 6, wherein a distal end of the diaphragm located at the outermost side of the bare cell body extends beyond the third end in a direction toward the fixing member.

10. The cell according to claim 7, wherein a distal end of the diaphragm located at the outermost side of the bare cell body extends beyond the third end in a direction toward the fixing member.

11. A battery assembly, comprising a cell, wherein the cell comprises a first electrode, a second electrode, a diaphragm and a fixing member;
wherein the first electrode, the diaphragm and the second electrode are laminated to one another and wound to form a bare cell body, the first electrode piece being disposed at an outermost side of the bare cell body; and
wherein the first electrode comprises a first end located on an outer surface of the bare cell body, the first electrode comprising a first active layer extending to the first end, the first end being fixed to the outer surface of the bare cell body by the fixing member.

12. An electronic device, comprising a battery assembly, wherein the battery assembly comprises a cell comprising a first electrode, a second electrode, a diaphragm and a fixing member;
wherein the first electrode, the diaphragm and the second electrode are laminated to one another and wound to form a bare cell body, the first electrode being disposed at an outermost side of the bare cell body; and
wherein the first electrode comprises a first end located on an outer surface of the bare cell body, the first electrode comprising a first active layer extending to the first end, and the first end being fixed to the outer surface of the bare cell body by the fixing member.
